(19) United States
(12) Patent Application Publication
(10) Pub. No.: US 2008/0154979 A1
(43) Pub. Date: Jun. 26, 2008

(54) APPARATUS, SYSTEM, AND METHOD FOR CREATING A BACKUP SCHEDULE IN A SAN ENVIRONMENT BASED ON A RECOVERY PLAN

(75) Inventors: Takashi Saitoh, Fujisawa-shi (JP); Soh Kaijima, Yokohamashi (JP)

Correspondence Address: Kunzler & McKenzie, 8 EAST BROADWAY, SUITE 600, SALT LAKE CITY, UT, 84111, US

(73) Assignee: INTERNATIONAL BUSINESS MACHINES CORPORATION, ARMONK, NY (US)

(21) Appl. No.: 11/614,737

(22) Filed: Dec. 21, 2006

(51) Int. Cl. G06F 17/30

(52) U.S. Cl. 707/202; 707/E17.007

(57) ABSTRACT

An apparatus, system, and method for creating a database backup schedule in a SAN environment based on a recovery plan. A user provides a desired recovery point objective (RPO) from a system recovery plan and an identifier of a database for back up. The present invention determines a priority (w) for a recent recovery point and determines a number (N) of volumes for storing backup images and a number (n) of database volumes used by the database. The present invention generates a scheduling formula where RPO is divided by the priority (w) of the most recent recovery point raised to the power of the truncated integer value of the ratio of volumes for storing backup images (N) and the number of volumes in use by the database (n) minus a scheduling interval determinant (i). The scheduling formula is used to determine a backup interval and backup assurance points.

### BACKGROUND OF THE INVENTION

1. Field of the Invention

This invention relates to SAN database technology and more particularly relates to the creation and execution of a backup plan for databases of a SAN based upon parameters given in a recovery plan for the overall SAN.

2. Description of the Related Art

Information constitutes the lifeblood of a business, and the volume of information necessary for business operations is continually increasing. Given the rise in both the importance and quantity of business information, new methods of storing and protecting it are constantly developing. One of the newer additions to the area of information storage is the storage area network, or SAN. A SAN is a high-speed network dedicated to transporting and managing data storage and retrieval. SANs provide tremendous storage capacity, often on the terabyte scale, along with additional recovery capability due to the SAN's ability to quickly mirror the data on the disks.

The advent of the SAN, however, also introduces complexity to the creation of a database backup schedule. Typically, a System Administrator provides a Database Administrator with a system recovery plan specifying a point in time to which the data must be recoverable in the case of a system failure. This point in time is commonly referred to as a recovery point objective, or RPO. The recovery plan also includes a time period tolerance within which the system must resume operations, commonly referred to as a recovery time objective, or RTO. The Database Administrator is responsible for taking the parameters of a system recovery plan and creating a backup plan for the database.

The Database Administrator must consider a number of competing factors in creating a backup schedule. Databases have logs associated with them that keep records of database changes. When a full backup is made of a database, logs can be used to ‘roll forward’ a database and recover data from a point after the full backup was made. When a full backup of a database is made, that backup copy constitutes a ‘recovery point’ from which a database administrator may roll forward to recover the database. Databases typically cannot, however, use logs to roll backwards. The choice of where recovery points are made affects both the RTO and the RPO. If a recovery plan specifies a long RPO, such as two weeks, data from the database copy from two weeks ago may be used, in conjunction with the logs, to recovery the database to 3 days ago. However, the need to roll the database forward 11 days results in a longer RTO. A recovery point at 4 days ago requires using the logs to move the database forward only 1 day and recovery occurs much faster. Numerous recovery points allow for a large RPO while maintaining a short RTO. The number of possible recovery points, however, is limited by factors such as the amount of space available to store full copies and the impact on network performance of generating multiple recovery points.

With the above considerations in mind, the Database Administrator creates a backup schedule and enters it into a software module designed to implement the plan, such as IBM's DB2 Universal Database software. The Database Administrator enters information such as the backup execution time, the backup intervals, where to backup, which databases to backup, and the backup conditions. However, as noted above, creating an effective backup schedule depends on considerations such as the amount of storage available, the data traffic on the SAN at a particular moment, the relative importance of the current data to other available data backup copies, and system requirements such as the amount of space occupied by the database to be backup up and the corresponding space that is available. In particular, in a SAN environment, the backup functionality of the SAN is limited in the number of backup images that can be retained which in turn is dependent on characteristics of the storage environment such as disk information that are unique to a SAN and typically not considered by the Database Administrator.

As such, it is difficult to take a System Administrator's recovery plan and quickly and accurately create a corresponding backup plan that is both efficient and takes into account the RPO, RTO, and characteristics of a SAN. Too few recovery points may result in the loss of critical data and unacceptably high recovery times, while too many recovery points may use space and resources on the SAN inefficiently. In addition, database backup schedules tend to be static creations that simply backup at regularly scheduled intervals regardless of the relative importance of data at a particular point in time. It is difficult to include the fact that older database copies tend to be less important than more recent database copies in the creation of a database backup schedule.

There is a need for an apparatus capable of taking parameters from a system recovery plan, considering the characteristics of the SAN, and then translating that information into an optimized backup schedule that ensures data recovery within a reasonable time period without using more space or computing resources than necessary.

### SUMMARY OF THE INVENTION

The present invention has been developed in response to the present state of the art, and in particular, in response to the problems and needs in the art that have not yet been fully solved by currently available apparatus and methods. Accordingly, the present invention has been developed to provide a backup schedule that accounts for both the requirements of a system administrator's recovery plan and the unique characteristics of a particular SAN.

In one aspect of the invention, a computer program product creates a backup schedule based on a user-provided identifier of a database to be backed up and desired recovery point objective (RPO) that defines a time period for which system data is guaranteed recoverable, the RPO is defined within a predefined recovery plan. The computer program product determines a priority (w) for a most recent recovery point of the predefined recovery plan. This determination may be made using a default value or based on user input.

The computer program product automatically determines a number (N) of volumes available for storing backup images of the database and a number (n) of database volumes in use by the database that is being backed up. Using this information, the computer program product generates a backup scheduling formula such that the RPO is divided by the priority (w) of the most recent recovery point raised to the power of the truncated integer value of the ratio of the number of volumes available for storing backup images of the database (N) and the number of volumes in use by the database that is being backed up (n) minus a scheduling interval determinant (i).

The computer program product determines the backup interval using the backup scheduling formula where the RPO is divided by the priority (w) of the most recent recovery point raised to the power of the truncated integer value of the ratio of the number of volumes available for storing backup images of the database (N) and the number of volumes in use by the database that is being backed up (n) minus a scheduling interval determinant (i), which scheduling interval determinant has an integer value of the priority (w) of the most recent recovery point.

Recovery assurance periods are determined by the backup scheduling formula with the value of the scheduling interval determinant (i) having an integer greater than the priority (w) of the most recent recovery point and less than the truncated integer value of the ration of the number of volumes (N) available for storing backup images of the database and the number of volumes (n) in use by the database that is being backed up.

The computer program product also causes the computer to periodically determine database activity and automatically adjust the backup schedule such that the backup operation is performed during a time period that imposes a minimal disruption to a SAN Input/Output (IO) workload.

The computer program product also causes the computer to autonomically modify a backup schedule based on a recovery history indicating an optimal assurance period different from the current assurance period. The computer program product determines the value of the priority (w) of the most recent recovery point in the backup scheduling formula which achieves the optimal assurance period and modifies the backup schedule using the determined value of the priority.

The computer program product, in one embodiment, causes the computer to skip a backup operation of the database for a backup interval in which changes to the database do not exceed a predefined activity threshold.

In one embodiment, a system comprises an input module configured to receive, from a user, a desired recovery point objective (RPO) that defines a time period for which system data is guaranteed recoverable, the RPO defined within a predefined recovery plan, and receive, from a user, an identifier of the database to be backed up. The system also comprises a backup copy module configured determine a number (N) of volumes available for storing backup images of the database, and determine a number (n) of database volumes in use by the database that is being backed up.

The system also comprises a backup scheduler module configured to determine a priority (w) for a most recent recovery point of the predefined recovery plan, and generate a backup scheduling formula:

$$\frac{RPO}{{w}^{( [ \frac{N}{n} ] - i )}}$$

where the RPO is the desired recovery point objective, w is the priority of the most recent recovery point, N is the number of volumes available for storing backup images of the database, n is the number of volumes in use by the database that is being backup up, and i is the scheduling interval determinant.

The system also comprises a backup database rotation module configured to determine: a backup interval, which backup interval is based the backup scheduling formula in which the scheduling interval determinant (i) has the value of the priority (w) of the most recent recovery point; and data recovery assurance periods, which recovery periods are based on the backup scheduling formula in which the scheduling interval determinant (i) has an integer value greater than (w) and less than [N/n].

The system also comprises a backup execution module configured to register a backup schedule in a scheduler, the backup schedule comprising the identifier of the database to be backed up, a location on the SAN for storing the backup copy of the database, and a backup interval derived from the backup scheduling formula where the scheduling interval determinant is equal to w and to periodically determine database activity such that the backup operation is performed during a time period that imposes a minimal disruption to a SAN Input/Output (IO) workload;

The system further comprises a schedule modification module configured to autonomically modify a backup schedule based on a recovery history indicating an optimal assurance period different from the current assurance period, the schedule modification module determining the value of w in the backup scheduling formula which achieves the optimal assurance period and modifying the backup schedule using the determined value of w.

The system further comprises a backup optimization module configured to cause the backup execution module to skip a backup operation of the database for a backup interval in which changes to the database do not exceed a predefined activity threshold

The present invention provides novel apparatus and methods for creating a backup schedule for a SAN based on a recovery plan. The features and advantages of the present invention will become more fully apparent from the following description and appended claims, or may be learned by the practice of the invention as set forth hereinafter.

### BRIEF DESCRIPTION OF THE DRAWINGS

In order that the advantages of the invention will be readily understood, a more particular description of the invention briefly described above will be rendered by reference to specific embodiments illustrated in the appended drawings. Understanding that these drawings depict only typical embodiments of the invention and are not therefore to be considered limiting of its scope, the invention will be described and explained with additional specificity and detail through the use of the accompanying drawings, in which:

FIG. 1 is a schematic block diagram illustrating one embodiment of a SAN backup apparatus in accordance with the present invention;

FIG. 2A is a schematic block diagram illustrating a backup schedule created in accordance with the present invention;

FIG. 2B is a schematic block diagram illustrating the process of selecting an existing backup database copy for reuse as a current backup database copy; and

FIG. 3 is a schematic flow chart diagram illustrating one embodiment of a method for creating a database backup schedule in a SAN environment based on a recovery plan.

### DETAILED DESCRIPTION OF THE INVENTION

It will be readily understood that the components of the present invention, as generally described and illustrated in the Figures herein, may be arranged and designed in a wide variety of different configurations. Thus, the following more detailed description of the embodiments of the apparatus and methods of the present invention, as represented in the Figures, is not intended to limit the scope of the invention, as claimed, but is merely representative of selected embodiments of the invention.

Many of the functional units described in this specification have been labeled as modules, in order to more particularly emphasize their implementation independence. For example, a module may be implemented as a hardware circuit comprising custom VLSI circuits or gate arrays, off-the-shelf semiconductors such as logic chips, transistors, or other discrete components. A module may also be implemented in programmable hardware devices such as field programmable gate arrays, programmable array logic, programmable logic devices or the like.

Modules may also be implemented in software for execution by various types of processors. An identified module of executable code may, for instance, comprise one or more physical or logical blocks of computer instructions which may, for instance, be organized as an object, procedure, or function. Nevertheless, the executables of an identified module need not be physically located together, but may comprise disparate instructions stored in different locations which, when joined logically together, comprise the module and achieve the stated purpose for the module.

Indeed, a module of executable code could be a single instruction, or many instructions, and may even be distributed over several different code segments, among different programs, and across several memory devices. Similarly, operational data may be identified and illustrated herein within modules, and may be embodied in any suitable form and organized within any suitable type of data structure. The operational data may be collected as a single data set, or may be distributed over different locations including over different storage devices, and may exist, at least partially, merely as electronic signals on a system or network.

Reference throughout this specification to “one embodiment,” “an embodiment,” or similar language means that a particular feature, structure, or characteristic described in connection with the embodiment may be included in at least one embodiment of the present invention. Thus, appearances of the phrases “in one embodiment” or “in an embodiment” in various places throughout this specification are not necessarily all referring to the same embodiment.

Furthermore, the described features, structures, or characteristics may be combined in any suitable manner in one or more embodiments. In the following description, specific details may be provided, such as examples of programming, software modules, user selections, etc., to provide a thorough understanding of embodiments of the invention. One skilled in the relevant art will recognize, however, that the invention can be practiced without one or more of the specific details, or with other methods, components, etc. In other instances, well-known structures, or operations are not shown or described in detail to avoid obscuring aspects of the invention.

The illustrated embodiments of the invention will be best understood by reference to the drawings, wherein like parts are designated by like numerals throughout. The following description is intended only by way of example, and simply illustrates certain selected embodiments of apparatus and methods that are consistent with the invention as claimed herein.

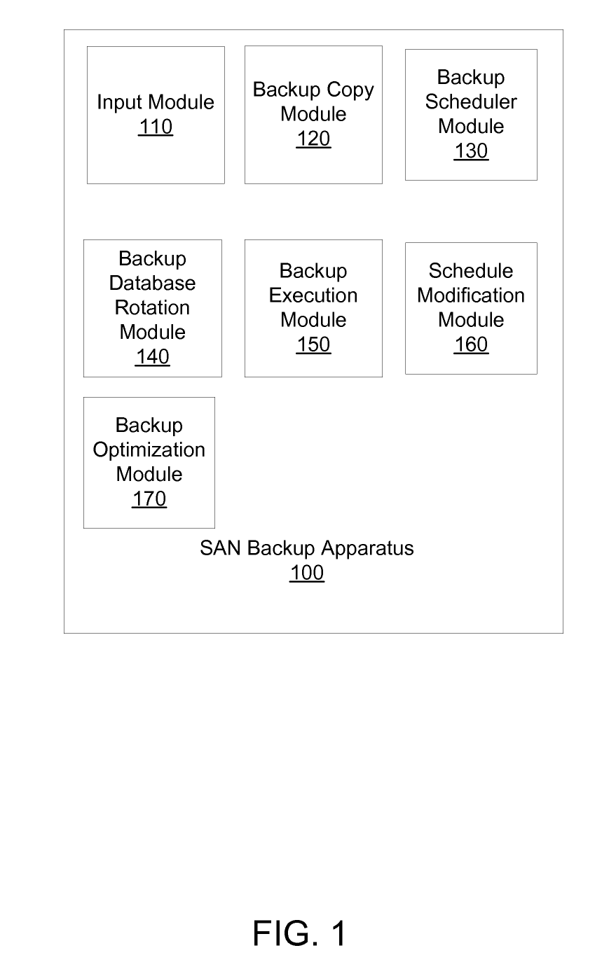

Referring to FIG. 1, one embodiment of a SAN backup apparatus 100 is illustrated. The SAN backup apparatus 100 is installed on a host as part of a database management system and includes an input module 110, a backup copy module 120, a backup scheduler module 130, a backup database rotation module 140, a backup execution module 150, a schedule modification module 160, and a backup optimization module 170.

The input module 110 is configured to receive input from the user concerning the recovery plan. The user, in one embodiment, provides the RPO from the recovery plan along with a priority of the most recent backup point and an identifier of the database to be backed up. In another embodiment, the RPO, priority of the most recent backup point and identifier of the database to be backed up are default values or values set in configuration information of the SAN backup apparatus 100.

The backup copy module 120 manages backup copies of databases. Specifically, the backup copy module 120 manages space for the creation and maintenance of the backup copies. In one embodiment, the backup copy module 120 determines the number of volumes used by the database to be backed up and the number of volumes that are available in the SAN for storing backup images.

The backup scheduler module 130 determines the parameters for the creation of a backup schedule. In one embodiment, the backup scheduler module 130 uses the information gathered by the input module 110 and backup copy module 120 to create a backup schedule formula. The backup scheduler module 130 determines the backup schedule formula as:

$$\frac{RPO}{{w}^{( [ \frac{N}{n} ] - i )}} ,$$

where the RPO is the desired recovery point objective, w is the priority of the most recent backup point, N is the number of volumes available to store backup images, n is the number of volumes used by the database, and i is a schedule interval determinant. If the user does not provide a priority of the most recent recovery point (w), a default value is assigned by the backup scheduler module 130. The value of (w) must be greater than 0 and less than the truncated integer value of the ratio [N/n]. The backup scheduler module also truncates the ratio N/n such that the result is an integer.

The backup database rotation module 140 determines the appropriate backup interval period and appropriate recovery assurance periods. The backup database rotation module 140 is configured to determine the amount of time which passes between successive backups, referred to herein as the backup interval. The backup database rotation module 140 uses the formula provided by the backup scheduler module 130 and sets the value of the schedule interval determinant (i) equal to the value of the priority of the most recent point (w). The resulting value is the backup interval which constitutes the amount of time which should pass after a backup is taken before another backup is attempted.

The backup database rotation module 140 is also configured to determine the amount of time separating data recovery assurance points, referred to herein as the data recovery assurance periods. The backup database rotation module 140 uses the formula provided by the backup scheduler module 130 and sets the value of the schedule interval determinant (i) to the integer value that is one greater than the priority of the most recent point (w) and less than or equal to the truncated integer value of the ratio N/n. The resulting value is the first assurance period point. The backup database rotation module 140 repeats this process for each integer value of i greater than w and less than or equal to the integer value of N/n.

The backup database rotation module 140 uses the determined backup intervals, data recovery assurance periods, and the number of available locations for the database backups to coordinate the rotation of the volumes such that the assurance period and interval requirements are met. When two database copies can guarantee recovery of a particular recovery assurance point, the backup database rotation module 140 selects one database copy to guarantee the recovery assurance point and flags the other as available storage space. If the two database copies can guarantee recovery for an assurance point which is earlier than the last guaranteed assurance point, the database rotation module 140 selects the older of the two database copies to guarantee the assurance point and flags the other as available space. If the two database copies both guarantee recovery of the last recovery assurance point, the database rotation module 140 selects the earlier of the two database copies to guarantee the assurance point and flags the older as available space. If only one database copy can guarantee an assurance point, the database rotation module 140 flags that database copy as the guarantor of the particular assurance point.

The backup execution module 150 manages the actual execution of a backup operation. In one embodiment, the backup execution module 150 is configured to register the backup intervals, assurance periods, and rotation information determined by the backup database rotation module 140, along with the database identifier from the input module 110 and the location on the SAN for storing the backup copy from the backup copy module, as a backup schedule in a database scheduler.

The backup execution module 150 also stores and checks conditions for executing a backup operation. In one embodiment, the backup execution module 150 records and stores data concerning the number of operations performed by the SAN in an hour. The backup execution module 150 searches the record of daily statistics for a backup execution time period in which the execution of the backup will have the least influence on the regular operations of the database. In one embodiment, the backup execution module 150 may search an hourly transaction log of a day for the hour in which the number of transactions is the smallest and then perform the backup in that hour.

The schedule modification module 160 is configured to autonomically analyze recovery data and modify a backup schedule in order to minimize the recovery time necessary for the data. In one embodiment, the schedule modification module 160 records data from system failure events. The schedule modification module 160 may record, for example, which databases were recovered after the failure, the amount of time required to restore the data and the age of the copies from which the recovery was made. The accumulated data constitutes the recovery data for the SAN.

The schedule modification module 160 analyzes the recovery data to optimize the timing of the backup intervals and the recovery assurance periods. The schedule modification module 160, in one embodiment, may determine an alternative value for the priority of the most recent point (w), varying the frequency of the backups such that the data recovery time following a system failure is minimized. The schedule modification module 160 then provides this new value for the priority (w) to the backup scheduler module 130. The scheduling formula is then appropriately altered and the new interval and assurance period values are determined by the backup database rotation module 140. This new schedule is implemented by the backup execution module 150.

The backup optimization module 170 ensures that effective backups are made. The backup optimization module 170, in one embodiment, counts the number of actions affecting data in a database in a given backup interval time period. The backup optimization module 170 determines the average number of transactions in a backup interval and autonomically determines whether, in any given backup interval, a threshold amount of database activity (for example, 5% of normal database activity), has occurred. Absent a threshold amount of activity within the current backup interval period, the backup optimization module 170 instructs the backup execution module 150 not to execute the scheduled backup. For example, if a schedule requires daily backup intervals, but data traffic on Mondays is one percent that of other days of the week, the Monday database backup is not executed.

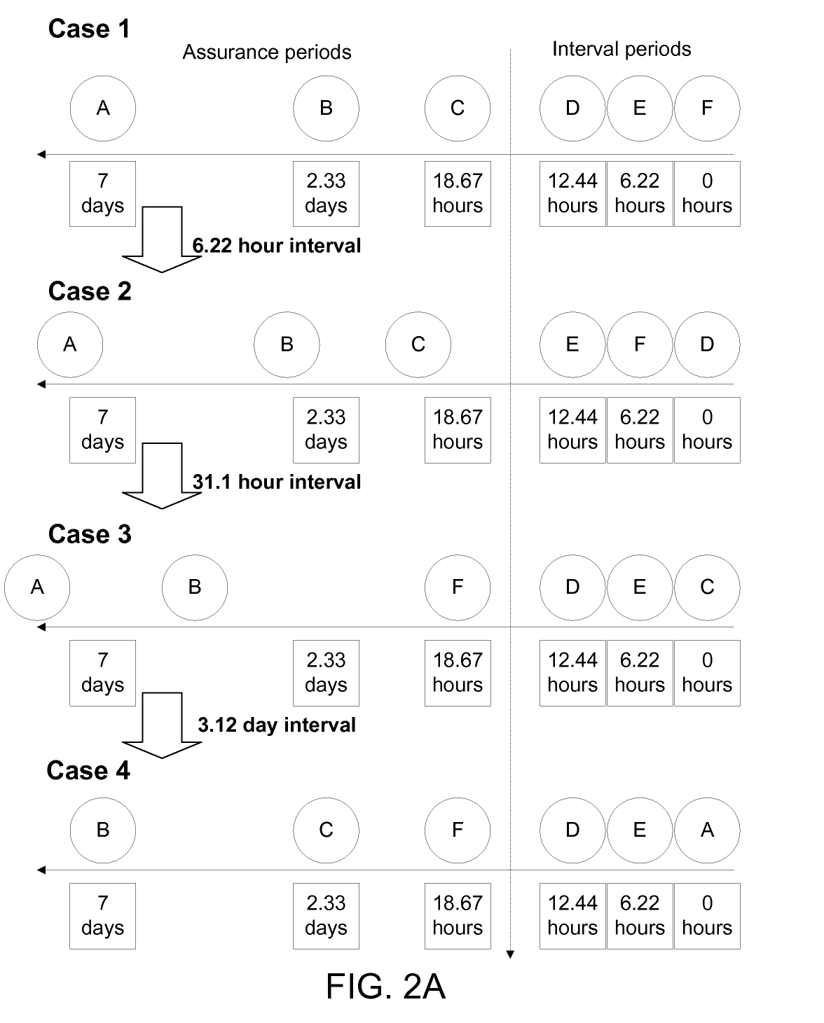

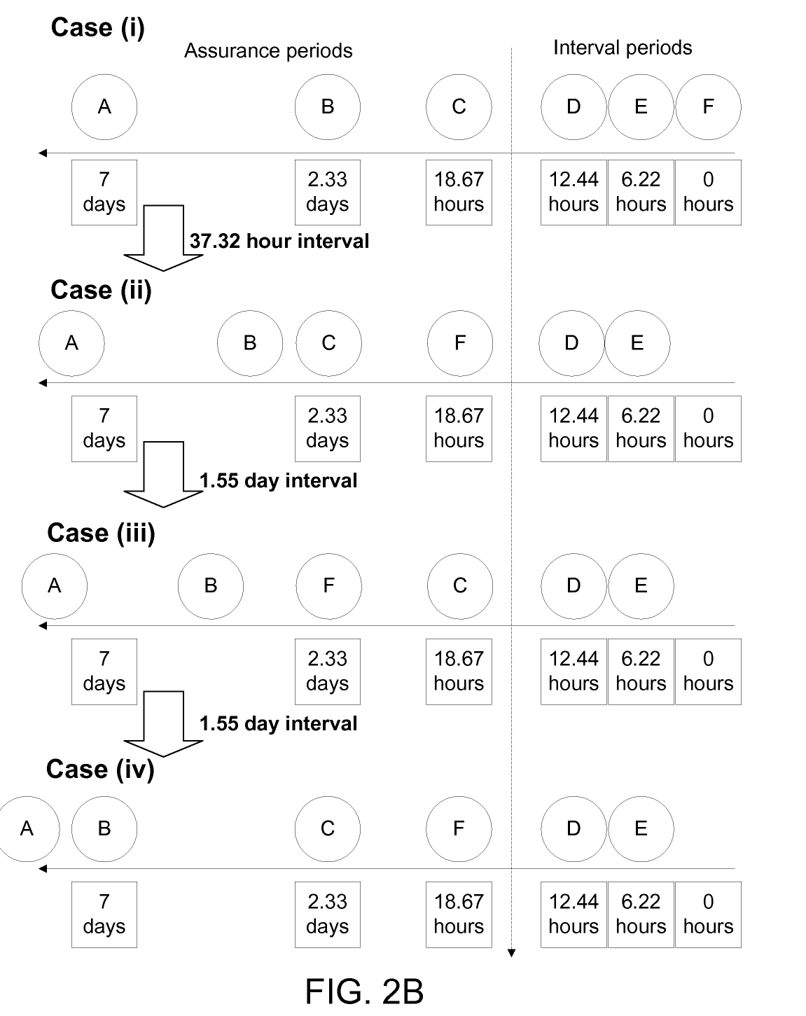

FIG. 2A is an illustrative example of a backup schedule created by the SAN backup apparatus 100. In the example, the user has specified a recovery point objective (RPO) of 7 days and given a priority (w) of 3 to the most recent recovery point. The database to be backed up occupies 2 volumes (n), and a total of 13 volumes are available for storing backup images of the database (N). The backup scheduler module 130 uses this information to create a backup schedule formula

$$\frac{7}{{3}^{( 6 - i )}}$$

where the value 6 is the truncated integer value of 13/2.

Using the formula above, the backup database rotation module 140 determines the backup interval by inserting a value i=w=3. The formula returns a value of 0.259 days, or approximately 6.22 hours which constitutes the backup interval period. The backup database rotation module 140 communicates this information to the backup execution module 150 which then schedules a backup every 6.22 hours.

The backup database rotation module 140 then inserts values for i equal to 4, 5, and 6 respectively. For i=4, the returned data recovery assurance period is 0.77 days, or approximately 18.67 hours. For i=5, the data recovery assurance period is 2.33 days. For i=6, the data recovery assurance period is 7 days. With six effective spaces A through F for the storage of copies of the database, the copies of the database hold information as shown in case 1 on FIG. 2A. Database copy A represents the first copy made and is the oldest, copy B represents a copy holding data 2.33 days old, and copy C holds data 18.67 hours old. Database copies A through C each represent distinct possible recovery points. Recovery from other points within the seven day period is also possible by rolling one of the database copies forward using database logs. In addition to the recovery assurance database copies A through C, the database copies D through F are used to create copies at regular backup intervals.

Case 2 shows the backup volumes after a 6.22 hour backup interval passes. Assuming that a threshold amount of data activity has occurred such that the backup optimization module 170 has not sent a message to skip the backup, a backup occurs and database copy D is rotated such that it is used to hold the current backup copy. Databases copies A through C, each assigned to provide a recovery assurance period, age 6.22 hours. Each database copy A through C can still guarantee recovery of data at the recovery assurance points by use of the database logs. A database administrator can roll forward a database to a desired point; however, the farther the point is in time from the current age of the database, the greater the time required because logs are read sequentially.

If, at case 2, recovery of data from two days ago were necessary, both database copy A and copy B could provide the information by use of the database logs. However, because database copy B is closer to the desired recovery point, copy B would be used as it can recover the data in the least amount of time. The present invention thus spaces backup intervals and recovery assurance periods such that the RTO is minimized for the parameters specified by the system and the recovery plan.

Case 3 represents the passage of 31.1 hours from the scenario presented in case 2. Database copies A and B each age an additional 31.1 hours, with A continuing in its assignment to the 7 day recovery assurance point and B continuing in its assignment to the 2.33 day recovery assurance point. The backup rotation module 140 flags database copy F to guarantee the 18.67 hour assurance point, and also flags database copy C as free for use. As such, database copy C is used for the current backup interval.

Case 4 represents the passage of an additional 3.12 days from case 3. Database copy B reaches an age of seven days and provides assurance for the maximal guaranteed recovery period of seven days. The backup database rotation module 140 flags database copy A as free space. Database copy A may then be used to meet the backup interval requirements. At this point in time, database C is approximately 2.33 days old, and database F is flagged to cover the assurance period of 18.67 hours. The rotation of databases to meet the backup interval requirements and the recovery assurance period requirements then continues as described above in connection with FIG. 2A.

Revisiting case 1, if during the 6.22 hour backup interval minimal database activity occurred, the backup optimization module 170 instructs the backup execution module 150 to skip the backup. In addition, the database copies are treated as if they had not aged by 6.22 hours, and the graphical representation of the databases would remain as shown in case 1, as opposed to that shown in case 2 even though a 6.22 time interval has passed.

If, after a period of time, the system experiences a number of failures, the schedule modification module 160 records data concerning the system restore process. The data may indicate that the data recovery in each instance was made using data that was a day old. Since this data indicates that the current database backup schedule is not optimized for an actual restore situation, the schedule modification module 160 may autonomically alter the value of the priority (w) of the most recent point and autonomically change the backup interval to one day. Alternatively, the schedule modification module 160 may prompt a user regarding making the changes.

With the parameters given in connection with FIG. 2, the schedule modification module 160 determines a value of w such that the backup interval is equal to one day. As such, schedule modification module 160 solves for the value of w such that

$$\frac{7}{{w}^{( 6 - w )}} = 1.$$

A value of w=4.75 solves the equation and is the new w value calculated by the schedule modification module 160 to optimize recovery. The new schedule modification module 160 provides the new value of w to the backup scheduler module 130. Using the new backup schedule formula, the backup database rotation module 140 calculates the new backup interval and data recovery assurance periods, which are then automatically implemented by the backup execution module 150.

FIG. 2B illustrates the process by which the database rotation module 140 selects an existing backup database copy for reuse as a current backup database copy and flags a database copy as the guarantor of a particular recovery assurance point. Case (i) shows the initial location of database copies A through F along a timeline, as in Case 1 of FIG. 2A. After a 37.32 hour time interval, database copies A, B and C each age by 37.32 hours. At this point, corresponding to case (ii) on FIG. 2B, both database copies B and C can guarantee the data for the 2.33 day assurance point. Database copy F can guarantee the 18.67 hour assurance period. Since a database copy must be reused in order to meet the required backup interval and fill the “current” position on the timeline, and because two databases guarantee recovery at 2.33 days, the backup database rotation module 140 chooses the older database copy, which is in this case database copy B, to guarantee the 2.33 day z assurance point. The database rotation module 140 flags database copy C as available and it is used for the current backup, as illustrated in case 3 of FIG. 2A. The database rotation module 140 also flags database copy F as the guarantor of the 18.67 hour recovery point.

Case (iii) illustrates the passage of an additional 1.55 days from case (ii). Database copies A and B continue to age, and database copy F reaches the 2.33 day assurance point. Database copy C reaches the 18.67 hour assurance point. In this instance, both database copies B and F can guarantee the 2.33 day assurance point. The database rotation module 140 again chooses the older database copy B to provide assurance and flags database copy F as free. The database rotation module 140 also flags the database copy C to provide assurance for the 18.67 hour assurance point. Database copy F is used to meet the current backup requirement.

Case (iv) illustrates the situation after the passage of an additional 1.55 days from case (iii). Database copies A and B now guarantee the seven day assurance point. However, because seven days is the last assurance point, the database rotation module 140 flags the more current of the two, in this case database copy B, to guarantee the point. The database rotation module also flags database copy C as the guarantor of the 2.33 day recovery point and database copy F as the guarantor of the 18.67 hour assurance point. Database copy A is flagged as free and is used for the current backup, as shown in case 4 of FIG. 2.A.

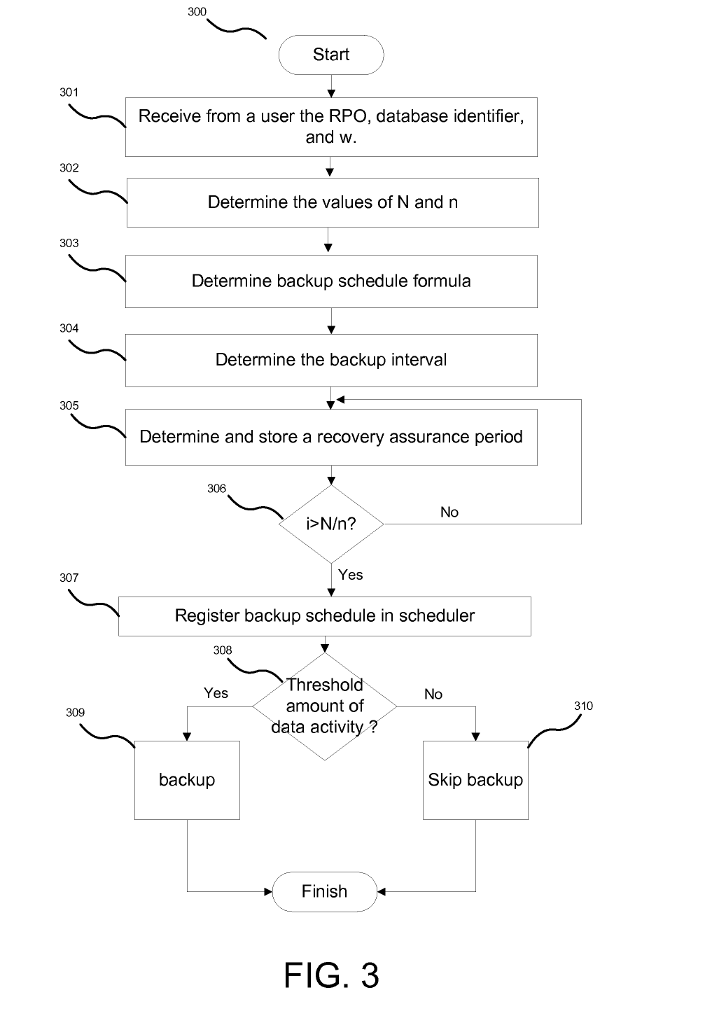

FIG. 3 is a schematic flow chart diagram illustrating a method 300 for creating a backup schedule based on a recovery plan in a SAN environment. The method 300 starts 301 and the user provides the recovery point objective (RPO) representing the guaranteed recovery period. The user also provides a database identifier and a priority (w) of a most recent recovery point. Next, the system backup copy module 120 determines 302 the number of volumes (N) available for storing backup images of the database and the number (n) of database volumes in use by the database that is being backed up.

Next, the backup scheduler module 130 determines 303 a backup schedule formula from the parameters mentioned above such that

$$\frac{RPO}{{w}^{( [ \frac{N}{n} ] - i )}} .$$

The backup database rotation module 140 sets the schedule interval determinant (i) equal to the priority (w) value in the backup schedule formula and evaluates the formula to determine 304 the backup interval. The backup database rotation module 140 sets the schedule interval determinant (i) to the next integer value greater than w but less than the truncated integer ratio of N/n to determine 305 a first recovery assurance period. The backup database rotation module 140 stores the first recovery assurance period. Next, the backup database rotation module 140 determines 306 whether the value substituted for i is greater than the truncated integer ratio of N/n. If not, the backup database rotation module 140 determines 306 another recovery assurance period.

If so, the backup execution module 150 registers 307 the determined backup schedule in a scheduler for execution. In one embodiment, the backup execution module 150 determines 308 whether a threshold amount of data activity has occurred. If the threshold has been met, the backup execution module 150 schedules 309 the backup in a scheduler tool such as cron or other well known schedulers. Otherwise, the backup execution module 150 skips 310 the backup interval and the method 300 ends.

The present invention may be embodied in other specific forms without departing from its spirit or essential characteristics. The described embodiments are to be considered in all respects only as illustrative and not restrictive. The scope of the invention z is, therefore, indicated by the appended claims rather than by the foregoing description. All changes which come within the meaning and range of equivalency of the claims are to be embraced within their scope.

What is claimed is:

1. A computer program product for creating a database backup schedule in a SAN environment based on a recovery plan comprising a computer useable medium including a computer readable program, wherein the computer program product when executed on a computer causes the computer to:
receive, from a user, a desired recovery point objective (RPO) that defines a time period for which system data is guaranteed recoverable, the RPO defined within a predefined recovery plan;
receive, from a user, an identifier of a database to be backed up;
determine a priority (w) for a most recent recovery point of the predefined recovery plan;
automatically determine a number (N) of volumes available for storing backup images of the database;
automatically determine a number (n) of database volumes in use by the database that is being backed up;
generate a backup scheduling formula such that the RPO is divided by the priority (w) of the most recent recovery point raised to the power of the truncated integer value of the ratio of the number of volumes available for storing backup images of the database (N) and the number of volumes in use by the database that is being backed up (n) minus a scheduling interval determinant (i).

2. The computer program product of claim 1, wherein a backup interval is determined by the backup scheduling formula where the RPO is divided by the priority (w) of the most recent recovery point raised to the power of the truncated integer value of the ratio of the number of volumes available for storing backup images of the database (N) and the number of volumes in use by the database that is being backed up (n) minus a scheduling interval determinant (i), which scheduling interval determinant has an integer value of the priority (w) of the most recent recovery point.

3. The computer program product of claim 1, wherein a data recovery assurance period is determined by the backup scheduling formula where the RPO is divided by the priority (w) of the most recent recovery point raised to the power of the truncated integer value of the ratio of the number of volumes available for storing backup images of the database (N) and the number of volumes in use by the database that is being backed up (n) minus a scheduling interval determinant (i), which scheduling interval determinant has an integer value greater than the priority of the most recent recovery point (w) and less than the truncated integer value of the ratio of the number of volumes available for storing backup images of the database (N) and the number of volumes in use by the database that is being backed up (n).

4. The computer program product of claim 1, wherein the computer program product causes the computer to register a backup schedule in a scheduler, the backup schedule comprising the identifier of the database to be backed up, a location on the SAN for storing the backup copy of the database, and a backup interval derived from the backup scheduling formula where the scheduling interval determinant is equal to the priority (w) of the most recent recovery point.

5. The computer program product of claim 1, wherein the computer program product causes the computer to periodically determine database activity and automatically adjust the backup schedule such that the backup operation is performed during a time period that imposes a minimal disruption to a SAN Input/Output (IO) workload.

6. The computer program product of claim 1, wherein the computer program product causes the computer to autonomically modify a backup schedule based on a recovery history indicating an optimal assurance period different from the current assurance period, the computer determining the value of the priority (w) of the most recent recovery point in the backup scheduling formula which achieves the optimal assurance period and modifying the backup schedule using the determined value of the priority.

7. The computer program product of claim 1, wherein the computer program product causes the computer to skip a backup operation of the database for a backup interval in which changes to the database do not exceed a predefined activity threshold.

8. An apparatus for creating and modifying a database backup schedule in a SAN environment based on a SAN recovery plan, the apparatus comprising:
an input module configured to receive, from a user, a desired recovery point objective (RPO) that defines a time period for which system data is guaranteed recoverable, the RPO defined within a predefined recovery plan, and receive, from a user, an identifier of the database to be backed up;
a backup copy module configured determine a number (N) of volumes available for storing backup images of the database, and determine a number (n) of database volumes in use by the database that is being backed up;
a backup scheduler module configured to determine a priority (w) for a most recent recovery point of the predefined recovery plan, and generate a backup scheduling formula:
$$\frac{RPO}{{w}^{( [ \frac{N}{n} ] - i )}}$$
where
RPO=the desired recovery point objective;
w=the priority of the most recent recovery point;
N=the number of volumes available for storing backup images of the database;
n=the number of volumes in use by the database that is being backed up;
i=the scheduling interval determinant;
a backup database rotation module configured to determine:
a backup interval, which backup interval based on the backup scheduling formula in which the scheduling interval determinant has the value of the priority (w) of the most recent recovery point;
data recovery assurance periods, wherein a data recovery assurance period based on the backup scheduling formula in which the scheduling interval determinant has an integer value greater than w and less than [N/n];
a backup execution module configured to:
register a backup schedule in a scheduler, the backup schedule comprising the identifier of the database to be backed up, a location on the SAN for storing the backup copy of the database, and a backup interval derived from the backup scheduling formula where the scheduling interval determinant is equal to w and to periodically determine database activity such that the backup operation is performed during a time period that imposes a minimal disruption to a SAN Input/Output (IO) workload;
a schedule modification module configured to autonomically modify a backup schedule based on a recovery history indicating an optimal assurance period different from the current assurance period, the schedule modification module determining the value of w in the backup scheduling formula which achieves the optimal assurance period and modifying the backup schedule using the determined value of w; and
a backup optimization module configured to cause the backup execution module to skip a backup operation of the database for a backup interval in which changes to the database do not exceed a predefined activity threshold.

10. The apparatus of claim 8, wherein the backup database rotation module is further configured to determine when a database copy is available free space and to determine which database copy is used to meet a backup interval.

11. The apparatus of claim 8, wherein the backup database rotation module is further configured to select the older of two database copies to guarantee a recovery assurance point, and to mark the earlier database as available storage, where the two database copies can both guarantee a recovery point which is earlier in time than the last recovery assurance point.

12. The apparatus of claim 8, wherein the backup database rotation module is further configured to select the earlier of two database copies to guarantee a recovery assurance point, and to mark the older database as available storage, where the two database copies can both guarantee the last recovery assurance point.

13. The apparatus of claim 8, wherein the backup database rotation module is further configured to mark a database copy which can guarantee recovery of a recovery assurance point as the guarantor of that recovery assurance point.
